(19) United States
(12) Patent Application Publication
(10) Pub. No.: US 2026/0115708 A1
(43) Pub. Date: Apr. 30, 2026

(54) ALTERNATE INJECTION METHOD FOR CLEANING FIXED BED REACTOR CATALYST BED IN SITU WITH CLEANING SOLVENT

(71) Applicant: United Laboratories International, LLC, Houston, TX (US)

(72) Inventors: Clint A. Arnold, League City, TX (US); Stephen D. Matza, Sugar Land, TX (US)

(21) Appl. No.: 18/862,826

(22) PCT Filed: May 5, 2023
(86) PCT No.: PCT/US2023/021212

§ 371 Date: Nov. 4, 2024

Related U.S. Application Data
(60) Provisional application No. 63/338,763, filed on May 5, 2022.

(51) Int. Cl. B01J 38/62; B01J 38/52

(52) U.S. Cl. CPC B01J 38/62; B01J 38/52

(57) ABSTRACT

A method for decontaminating refinery equipment. In one embodiment, the method comprises injecting a chemistry into a feed line of a refinery system unit at a low-pressure region via reciprocating drum pumps, wherein the low-pressure region is upstream of a reactor circuit of the refinery system unit. Further the method comprises allowing the chemistry to flow as a liquid through the feed line of the refinery system unit to be joined by a hydrogen stream that takes up, vaporizes, and carries the chemistry to the reactor circuit to thereby remove contaminants from equipment in the reactor circuit.

### CROSS-REFERENCE TO RELATED APPLICATIONS

The present application is a 35 U.S.C. § 371 U.S. National Phase entry of, and claims priority to, PCT Application PCT/US2023/021212 filed May 5, 2023, which claims priority to U.S. Provisional Application No. 63/338,763 filed May 5, 2022, each of which is hereby incorporated herein by reference in its entirety for all purposes.

### STATEMENT REGARDING FEDERALLY SPONSORED RESEARCH OR DEVELOPMENT

Not applicable.

### BACKGROUND OF THE INVENTION

Refineries may make use of reactors with hydrogenation catalysts to produce certain value-added products or remove contaminants to improve purity. Over time, these reactor catalyst beds may lose performance either due to catalyst poisoning or buildup of hydrocarbon deposits which may block active sites on the catalyst. Proper maintenance of these reactors may require that the catalyst undergo cleaning/decontamination prior to unloading and changeout.

There may be a number of procedures in existence for performing the cleaning/decontamination. One approach may involve a water fill and drain followed by a nitrogen purge. This practice may leave the catalyst clumped together, as water may be ineffectual at removing binding hydrocarbons. A second approach may make use of a liquid hydrocarbon circulation with additive chemistry that may be designed to either clean the hydrocarbon deposits from the catalyst or alternatively coat the catalyst to prevent pyrophoricity during exposure to the atmosphere at unloading. These circulation procedures may require a tremendous amount of time and expensive nitrogen to remove residual hydrocarbon vapors (LEL vapors) before entry may be safely accomplished. The most widely used approach may involve using a hydrogen utility (which may be part of the hydrogenation process) as a sweep stream to push out LEL vapors and soften asphaltenic and coke deposits for easier removal. Nitrogen may then be used to sweep out the hydrogen. This process may also take a very long time as LEL vapors are often persistent.

As a result, the hydrogen sweep process may have been recently fortified by addition of solvent chemistry injected directly into the high-pressure hydrogen gas stream. The chemistries may be designed to either dissolve deposited hydrocarbons or scrub and absorb LEL vapors. Supplementing the hydrogen sweep/nitrogen purge with chemistry may allow for readying the reactor for maintenance in a significantly shorter time. However, injecting chemistry directly into the high-pressure hydrogen stream as part of a conventional hydrogen sweep requires special pumps for overcoming the high hydrogen pressures.

### BRIEF SUMMARY OF SOME OF THE PREFERRED EMBODIMENTS

These and other needs in the art are addressed in one embodiment by a method for decontaminating refinery equipment comprising injecting a chemistry into a feed line of a refinery system unit at a low-pressure region via reciprocating drum pumps, wherein the low-pressure region is upstream of a reactor circuit of the refinery system unit. Further the method comprises allowing the chemistry to flow as a liquid through the feed line of the refinery system unit to be joined by a hydrogen stream that takes up, vaporizes, and carries the chemistry to the reactor circuit to thereby remove contaminants from equipment in the reactor circuit.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a schematic of equipment and process flow streams of an industrial hydrodesulfurization unit of a typical refinery.

### DETAILED DESCRIPTION OF THE PREFERRED EMBODIMENTS

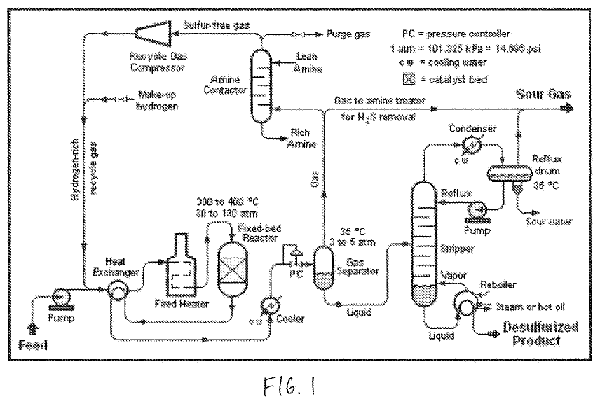

The present invention may provide an alternative injection technique for introducing a cleaning solvent or chemistries used to enhance the catalyst cleaning and LEL vapor removal ability of a hydrogen sweep/nitrogen purge for hydroprocessing reactors. In embodiments, a chemistry may be injected in a low-pressure region upstream of a reactor circuit and allowed to flow as a liquid to a tee where it may be taken up into a hot hydrogen by the Venturi effect and vaporized. A Feed Surge Drum may be isolated at the drum or the suction of the Feed Pump of FIG. 1 (normally the first piece of equipment on the unit operating at a relatively low pressure of around 15˜20 psi). In embodiments, the chemistry may be injected into the low pressure side of the feed line with reciprocating drum pumps. The feed line may gradually be filled with the chemistry, as the pumping continues, until a point where the chemistry starts to carry over past the tee where the hydrogen ties in. From that point the hydrogen may take up the chemistry, vaporize it, and carry it to the reactor section. The Feed Pump would not be used to move the chemistry. Once in contact with the reactor section, the vaporized chemistry may be capable of removing contaminants from equipment of the reactor section.

In embodiments, moving the injection point for the chemistry back upstream to a low pressure and lower temperature region allows the chemistry to be injected using less specialized pump equipment. Furthermore, as the liquid chemistry traverses the piping after injection and on its way to uptake and vaporization in the hydrogen carrier stream, it provides liquid contact cleaning of the piping and feed exchangers along the way which might otherwise be bypassed with a direct injection of the chemistry into the high-pressure hydrogen.

In embodiments, the chemistry or solvent composition utilized by the present invention may be disclosed in U.S. Patent Application Publication No. 2020-0276574 A1 and/or U.S. Patent Application Publication No. 2021-0023548 A1, the disclosures of which are incorporated by reference herein in their entirety.

In an embodiment, the solvent composition may comprise a fatty acid methyl ester and an oxygenated solvent. The fatty acid methyl ester may be the product of transesterification of soybean oil with methanol, for example. The fatty acid methyl ester may also be a biodiesel or a biodiesel equivalent blend. In some embodiments, the fatty acid methyl ester may comprise structure (1) where R is a C14-C15 alkyl group.

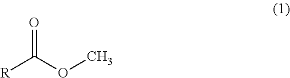

In embodiments, the oxygenated solvent may comprise glycol ethers such as di-propylene glycol, alcohols such as benzyl alcohol, esters such as ethyl lactate, ethoxylated alcohols, glycol ether acetates or combinations thereof. Further, the oxygenated solvent may be an effective scrubber for removal of or lowering the concentration of aromatic dispersed combustible materials (e.g., hydrocarbon vapors), thus lowering LEL vapor levels. Lowering LEL vapor levels may promote safe and effective vessel entry. In embodiments, the fatty acid methyl ester and oxygenated solvent may be present in any ratio in the solvent composition. Without limitation, the amount of fatty acid methyl ester and oxygenated solvent may depend on many factors including the identity of the fatty acid methyl ester and oxygenated solvent. In embodiments, the fatty acid methyl ester may be present in an amount ranging between about 70% to about 100% by volume of the solvent composition with the balance volume being the oxygenated solvent or combination of aforementioned oxygenated solvents. Alternatively, the fatty acid methyl ester may be present at a point in a range of about 70% to about 75% by volume, about 75% to about 80% by volume, about 85% to about 90% by volume, about 90% to about 95% by volume, about 95% to about 99.5%, or about 99.5% to about 100% by volume of the solvent composition, or any value in between the explicitly stated ranges. One of ordinary skill in the art with the benefit of this disclosure should be able to select an appropriate identity and amount of fatty acid methyl ester and oxygenated solvent for a particular application.

In an alternative embodiment, the solvent composition may comprise a refinery cutting fluid and a hydrocarbon solvent. The refinery cutting fluid may be any material capable of being naturally distilled from crude oil. At many refineries, crude oil comprising a mixture of various hydrocarbons, may undergo a distillation process. The distillation process aims to separate the crude oil into its various components including, without limitation, residual fuel oil, heavy gas oil, distillate (diesel), kerosene, naphtha, gasoline blending components, butane, and lighter products. In utilizing a naturally occurring refinery cutting fluid, utility costs for producing the solvent composition may be lowered and the flash point for shipping the solvent composition may be increased. In embodiments, the refinery cutting fluid may comprise diesel, kerosene, naphtha, or any combinations thereof. In embodiments, the refinery cutting fluid may be kerosene.

In embodiments, the hydrocarbon solvent may be any hydrocarbon compound. In embodiment the hydrocarbon compound may be bicyclic, comprising two fused benzene rings. The two fused benzene rings may be aromatic, saturated, or any combinations thereof. In embodiments, the two fused benzene rings may comprise one aromatic ring and one saturated ring which may result in a hydrocarbon compound with a high Kauri Butanol (Kb) value. The Kb value is a standardized measure of solvent power for a hydrocarbon solvent. In embodiments, the hydrocarbon solvent may have a Kb value between about 120 Kb and about 150 Kb, or alternatively between about 130 Kb and about 140 Kb. In embodiments, the hydrocarbon solvent may have a Kb value of 132 Kb. A suitable hydrocarbon solvent may comprise, without limitation, naphthalene, tetralin, decalin, or any combinations thereof. In embodiments, the hydrocarbon solvent may be tetralin.

In embodiments, the hydrocarbon solvent and the carrier fluid may be present in any ratio in the solvent composition. In embodiments, the hydrocarbon solvent may be present in an amount ranging between about 60% to about 100% by volume of the solvent composition with the balance volume being the cutting fluid. Alternatively, the hydrocarbon solvent may be present at a point in a range of about 60% to about 70% by volume, about 70% to about 80% by volume, about 80% to about 90% by volume, about 90% to about 95% by volume, about 95% to about 99.5%, or about 99.5% to about 100% by volume of the solvent composition, or any value in between the explicitly stated ranges. One of ordinary skill in the art with the benefit of this disclosure should be able to select an appropriate identity and amount of the hydrocarbon solvent and cutting fluid for a particular application.

In embodiments, in which the oxygenated solvent is not utilized in the solvent composition, the removal of entrapped aromatic dispersed combustible materials may be accomplished by virtue of superior solvency for the deposits which serve to entrap the aromatic dispersed combustible materials. As such, these embodiments may also promote higher success rates for achieving adequate LEL levels to permit safe and effective vessel entry.

In embodiments, the solvent composition may have a boiling point in a range of about 125° C. to about 300° C. depending on the identity and volumetric ratio of the chemical species in the solvent composition. There may be advantages to relatively higher boiling point solvent compositions, namely that vapor phase chemistries have higher performance at relatively higher temperatures. A hot hydrogen strip process using a solvent composition having a relatively higher boiling point may be operable at relatively higher temperatures of about 260° C. to about 400° C. Further, there may be advantages to relatively lower boiling point solvent compositions, namely that the vapor phase chemistries may allow for the solvent composition to be introduced into industrial equipment operating at lower temperatures. A hot hydrogen strip process using a solvent composition having a relatively lower boiling point may be operable at relatively low temperatures of about 150° C. to about 300° C. For example, the solvent composition with the relatively lower boiling point may be used in a hot hydrogen strip process performed on catalysts associated with reactors utilized by certain industrial equipment. In embodiments, the industrial equipment may comprise, without limitation, hydrotreaters, naphtha hydrotreaters, hydrocrackers, or any combinations thereof.

In some embodiments, a non-petroleum based solvent may be employed, which comprises advantages for scrubbing heavier LEL vapors. Further, the present invention may rely on nitrogen for pyrophoric mitigation.

Although the present invention and its advantages have been described in detail, it should be understood that various changes, substitutions and alterations may be made herein without departing from the spirit and scope of the invention as defined by the appended claims.

1. A method for decontaminating refinery equipment comprising:
(A) injecting a chemistry into a feed line of a refinery system unit at a low-pressure region via reciprocating drum pumps, wherein the low-pressure region is upstream of a reactor circuit of the refinery system unit;
(B) allowing the chemistry to flow as a liquid through the feed line of the refinery system unit to be joined by a hydrogen stream that takes up, vaporizes, and carries the chemistry to the reactor circuit;
(C) allowing the vaporized chemistry to remove contaminants from equipment in the reactor circuit.

2. The method of claim 1, wherein the reactor circuit comprises a reactor having a hydrogenation catalyst disposed within the reactor.

3. The method of claim 2, wherein the reactor circuit further comprises a liquid-gas separator configured to receive a fluid from the reactor.

4. The method of claim 3, wherein the reactor circuit further comprises an amine contactor configured to receive a gas stream from the liquid-gas separator and to produce the hydrogen stream.

5. The method of claim 1, wherein the chemistry comprises a solvent.

6. The method of claim 5, wherein the solvent comprises a fatty acid methyl ester and an oxygenated solvent.

7. The method of claim 6, wherein the fatty acid methyl ester is a product of transesterification of soy oil with methanol.

8. The method of claim 7, wherein the fatty acid methyl ester comprises a fatty acid methyl ester with the following structure: 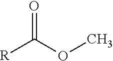
wherein R is a C₁₄-C₁₈ alkyl group.

9. The method of claim 6, wherein the oxygenated solvent comprises a solvent selected from the group consisting of di-propylene glycol, benzyl alcohol, ethyl lactate, an ethoxylated alcohol, glycol ether acetate, and combinations thereof.

10. The method of claim 6, wherein the fatty acid methyl ester is present in an amount from about 70% to about 99.5% by volume of the solvent.

11. The method of claim 5, wherein the solvent comprises a refinery cutting fluid and a hydrocarbon solvent.

12. The method of claim 11, wherein the hydrocarbon solvent is present in an amount from about 60% to about 99.5% by volume of the solvent.

13. A system for decontaminating refinery equipment comprising:
a feed line of a refinery system unit;
one or more reciprocating drum pumps configured to deliver a chemistry stream into the feed line in a low-pressure region, wherein the low-pressure region is upstream of a reactor circuit of the refinery system unit; and
a hydrogen stream configured to take up, vaporize, and carries the chemistry to the reactor circuit.

14. The system of claim 13, wherein the reactor circuit comprises a reactor having a hydrogenation catalyst disposed within the reactor.

15. The system of claim 14, wherein the reactor circuit further comprises a liquid-gas separator configured to receive a fluid from the reactor.

16. The system of claim 15, wherein the reactor circuit further comprises an amine contactor configured to receive a gas stream from the liquid-gas separator and to produce the hydrogen stream.

17. The system of claim 13, wherein the chemistry comprises a solvent.

18. The system of claim 17, wherein the solvent comprises a fatty acid methyl ester and an oxygenated solvent.

19. The system of claim 18, wherein the fatty acid methyl ester comprises a fatty acid methyl ester with the following structure: 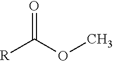
wherein R is a C₁₄-C₁₈ alkyl group.

20. The system of claim 18, wherein the oxygenated solvent comprises a solvent selected from the group consisting of di-propylene glycol, benzyl alcohol, ethyl lactate, an ethoxylated alcohol, glycol ether acetate, and combinations thereof.
